(19) United States
(12) Patent Application Publication
(10) Pub. No.: US 2023/0051360 A1
(43) Pub. Date: Feb. 16, 2023

(54) SIMULATED FLAME MECHANISM FOR ELECTRIC FIREPLACES

(71) Applicant: Wolf Steel Ltd., Barrie (CA)

(72) Inventors: Cuong Quoc Vo, Barrie (CA); David Shulver, Richmond Hill (CA); Jacob Wiltshire, Oro-Medonte (CA); Thiru Muruga Acharapakkam Doraiswamy, Barrie (CA)

(21) Appl. No.: 17/817,620

(22) Filed: Aug. 4, 2022

Related U.S. Application Data
(60) Provisional application No. 63/231,338, filed on Aug. 10, 2021.

(51) Int. Cl. F21S 10/04; F21V 14/00

(52) U.S. Cl. CPC F21S 10/04; F21V 14/003

(57) ABSTRACT

A simulated flame mechanism includes two or more projection surfaces and one or more flicker effects transmitting light onto the two or more projection surfaces. The projection surfaces are spaced apart and oriented relative to each other by one or more of (i) different elevations, (ii) different angular orientations in a horizontal plane, and (iii) different orientations in a vertical plane. The flicker elements generate an image of a simulated flame on the projection surfaces. The spacing and orientation of the two or more projection surfaces relative to each other creates a three-dimensional flame appearance when light from the one or more flicker effects is transmitted thereto.

### CROSS-REFERENCE TO RELATED APPLICATION(S)

This application claims priority to U.S. Provisional Application No. 63/231,338 filed on Aug. 10, 2021, which is incorporated by reference herein in its entirety.

### TECHNICAL FIELD

This disclosure relates generally to the field of electric fireplaces, and in particular to a simulated flame mechanism for use in such fireplaces.

### BACKGROUND

Electric fireplaces continue to increase in popularity, particularly in regions or applications where the aesthetic effect of a fireplace is desired, but where the burning of wood, natural gas or propane is prohibited or expensive, or where the heat output of a gas or wood-burning fireplace may not be necessary.

Advances in flame simulation technologies have enhanced the ability of manufacturers to offer products with a simulated flame that more closely mimics that of a traditional wood burning or gas burning fireplace. Nevertheless, in spite of advances that have been made in the electric fireplace industry, there continues to exist a desire on the part of both manufacturers and consumers alike to further enhance the visual effects of electric fireplaces so that they more closely align with those of a burning flame.

### SUMMARY

Accordingly, in an embodiment the disclosure provides a simulated flame mechanism for use in an electric fireplace, the simulated flame mechanism comprising two or more projection surfaces, spaced apart and oriented relative to each other by one or more of (i) different elevations, (ii) different angular orientations in a horizontal plane, and (iii) different orientations in a vertical plane; one or more flicker effects transmitting light onto the two or more projection surfaces and generating the image of a simulated flame on each of the projection surfaces, wherein the spacing and orientation of the two or more projection surfaces relative to each other creates a three-dimensional flame appearance when light from the one or more flicker effects is transmitted thereto.

In another embodiment there is provided a simulated flame mechanism for use in an electric fireplace, the simulated flame mechanism comprising: a first, a second, and a third projection surface, the projection surfaces spaced apart from one another with the second projection surface positioned between the first and the third projection surfaces, the first, second, and third projection surfaces oriented in a stepped configuration with the first projection surface at a first elevation, the second projection surface at a second elevation, and the third projection surface at a third elevation, the second elevation being greater than the first elevation and the third elevation being greater than the second elevation; and a flicker effect associated with each of the projection surfaces, each flicker effect transmitting light onto its respective projection surface to generate the image of a simulated flame on the respective projection surface, wherein the spacing apart of the projection surfaces and their stepped configuration creates a three-dimensional flame appearance when light from the flicker effects is transmitted onto the projection surfaces.

In yet a further embodiment the disclosure concerns a simulated flame mechanism for use in an electric fireplace, the simulated flame mechanism comprising two or more projection surfaces oriented relative to one another by one or more of (i) different elevations, (ii) different angular orientations in a horizontal plane, and (iii) different angular orientations in a vertical plane; a flicker effect associated with each of the projection surfaces, each flicker effect generating the image of a simulated flame on its respective projection surface; and a simulated fire log set comprising one or more simulated fire logs, one or more of the projection surfaces having an opening to receive a simulated fire log therethrough. In an embodiment the second elevation is greater that the first elevation and the third elevation is less that the second elevation.

### BRIEF DESCRIPTION OF THE DRAWINGS

For a better understanding of the present disclosure, and to show more clearly how it may be carried into effect, reference will now be made, by way of example, to the accompanying drawings which show exemplary embodiments of the present disclosure in which:

FIG. 1 is a front perspective view of an electric fireplace insert having a simulated flame mechanism in accordance with an embodiment of the disclosure.

FIG. 2 is an upper side perspective view of the simulated flame mechanism of the embodiment of the electric fireplace shown in FIG. 1.

FIG. 3 is a right side view of the simulated flame mechanism of FIG. 2.

FIG. 4 is a side elevation view of an alternate embodiment of the simulated flame mechanism shown in FIGS. 2 and 3.

FIG. 5 is an upper side perspective view of the simulated flame mechanism shown in FIG. 4.

FIG. 6 is a side elevation view of an alternate embodiment of the simulated flame mechanism shown in FIG. 5.

FIG. 7 is an illustrative view of a series of different forms of projection surfaces which could be used in different embodiments of the simulated flame mechanism in accordance with the disclosure.

FIG. 8 is an enlarged detail view of one embodiment of a flame generation module and a projection surface, wherein the projection surface includes flame cut-outs.

FIG. 9 is an alternate embodiment of the disclosure wherein projection surfaces have been oriented in an angular/intersecting manner to mimic the appearance of a bonfire or campfire.

FIG. 10 is an illustrative example of a further embodiment of the disclosure wherein multiple projection surfaces have been oriented in a discrete manner to create a customized flame appearance.

FIG. 11 is a view showing an embodiment of the disclosure where the projection surfaces include an opening through which a simulated log can extend.

FIG. 12 is a view showing an embodiment of the disclosure where the fire log set includes slots to receive projection surfaces therein.

FIG. 13 is a schematic drawing of an embodiment of the disclosure that utilizes electrochromic glass.

### DETAILED DESCRIPTION

The present disclosure may be embodied in a number of different forms. The specification and drawings that follow describe and disclose some of the specific forms of the disclosure.

With reference to the attached drawings, illustrative embodiments of a simulated flame mechanism constructed in accordance with the current disclosure will be described in further detail.

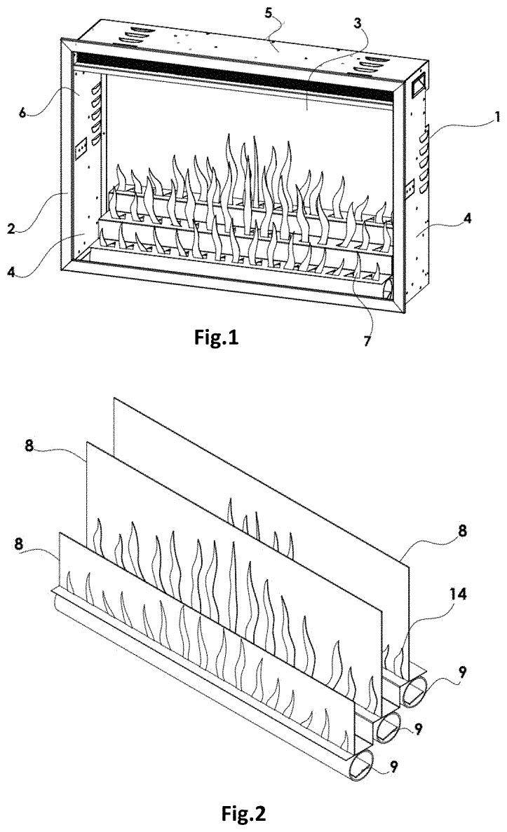

In FIG. 1 there is shown an electric fireplace 1 that is comprised generally of a housing 2 having a back 3, side surfaces 4, a top 5, and a front glass or viewing window 6. A simulated flame mechanism 7 is positioned within the housing and between glass 6 and back surface 3.

In accordance with the disclosure, simulated flame mechanism 7 is comprised of two or more projection surfaces 8 and one or more flicker effects 9 that transmit light onto the two or more projection surfaces in order to generate the image of a simulated flame on each of the respective projection surfaces. From a thorough understanding of the disclosure it will be appreciated that flicker effects 9 could take any one of a wide variety of different forms and structures. For example, flicker effects 9 may be in the form of a traditional rotating drum structure. Flicker effects 9 could alternately be one or more LED flicker effects that may be controlled by a processor to generate the desired colour and intensity of light that is transmitted to the projection surface or surfaces to create the image of a simulated or “dancing” flame that attempts to mimic the flame of a wood or gas burning fire. In the case of the disclosure shown in the attached drawings, each projection surface 8 has its own dedicated flicker effect 9, which in this instance is comprised of an LED-type flicker effect. Other forms, numbers and positioning of flicker effects are contemplated and remain within the scope of the disclosure.

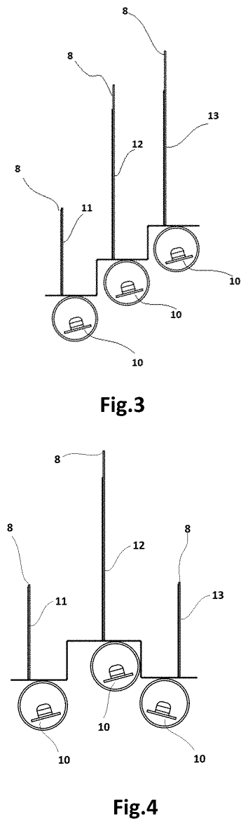

To enhance the image of a simulated flame on projection surfaces 8, and to help to create a three-dimensional flame appearance, the respective projection surfaces 8 are spaced apart and oriented relative to one another by one or more of (i) different elevations, (ii) different angular orientations in a horizontal plane, and (iii) different orientations in a vertical plane. For example, in the embodiment shown in FIGS. 2 and 3, the projection surfaces are oriented in a stepped configuration and at different elevations such that the projection of light onto the projection surfaces creates the appearance of flames at different heights, at different depths within housing 2. That is, in this particular embodiment the projection surfaces comprise a first projection surface 11, a second projection surface 12, and a third projection surface 13, where each of the respective surfaces are generally parallel to one another. The first projection surface 11 is positioned closest to glass 6 and the third projection surface 13 is positioned closest to back 3 of housing 2. Second projection surface 12 is located between the first and third projection surfaces. It will also be noticed through reference to FIGS. 2 and 3 that the stepped configuration of the projection surfaces results in second projection surface 12 being positioned and extending vertically higher than first projection surface 11. Similarly, third projection surface 13 is positioned and extends vertically higher than second projection surface 12. The net effect of the stepped configuration of the three projection surfaces creates the appearance of flames at an increasing height as one moves rearwardly from the front of housing 2 toward its back. In the depicted embodiment, each projection surface also has its own dedicated flicker effect, however, as noted previously other forms and other numbers of flicker effects could be used.

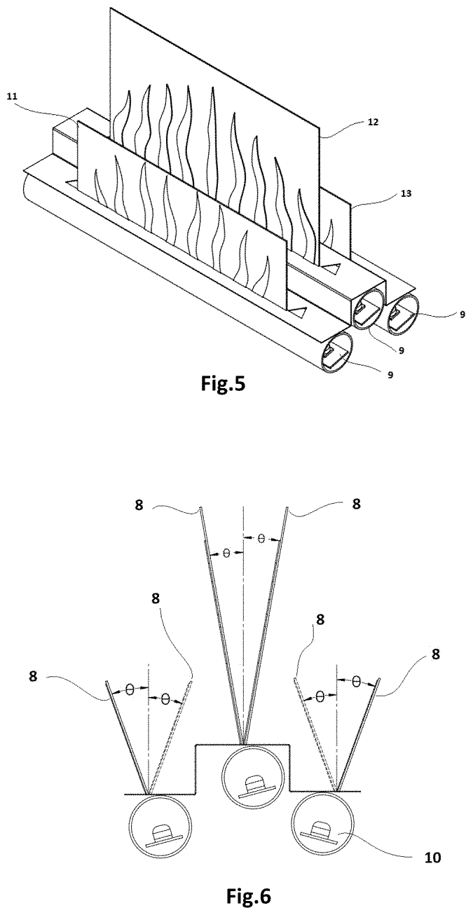

FIGS. 4 through 6 illustrate an alternate embodiment of projection surfaces, such as could typically be used in the case of a double-sided fireplace, wherein back 3 of housing 2 is a glass or viewing window, similar to front 6. In this embodiment, three separate projection surfaces are utilized. In other embodiments two or more surfaces could be present. With specific reference to FIG. 4, a first projection surface 11 is located adjacent to where glass 6 of the fireplace would be positioned, and a third projection surface 13 is oriented adjacent to where back 3 (comprised of glass or a viewing window) would be positioned. It will also be noted that second projection surface 12 is positioned between surfaces 11 and 13, and is at a higher elevation, and extends vertically upward to a greater degree, than first or third projection surfaces 11 and 13. In many applications of double-sided electric fireplaces, it is expected that first and third projection surfaces 11 and 13 would be positioned at approximately the same elevation and would extend upwardly to approximately the same degree.

Each projection surface in FIGS. 4 through 6 has its own dedicated flicker effect, however, other forms and orientations of flicker effects are contemplated. Further, one or more of the projection surfaces may also receive secondary projections from other or additional flicker elements or sources, in additional to projections from their dedicated flicker elements. The net result of the projection surfaces in the embodiment shown in FIGS. 4 through 6 is to create the image of flames on projection surfaces positioned at different “depths” within housing 2, and images of flames having different relative heights when viewed from either side of the fireplace.

It will also be appreciated by those of skill in the art that in this embodiment, as well as the other embodiments contemplated and described herein, that flicker effects 9 could be designed to project different forms or types of flame images on different projection surfaces. That is, in the example shown in FIG. 4 smaller, “lapping”, flame images could be transmitted to projection surfaces 11 and 13 to mimic the smaller types of flames that one may expect along the outermost portion of a fire. In contrast, the image of larger and more intense flames could be transmitted to second projection surface 12 to mimic the types of flames that one would typically expect to emanate from the middle of a burning fire. The combination of the multiple projection surfaces, their relative spacing and vertical offset or stepped orientation will thus enhance the three-dimensional appearance of the resulting image.

FIG. 6 demonstrates a further embodiment of the disclosure wherein one or more of the projection surfaces are oriented at an angle relative to vertical. FIG. 6 is intended to demonstrate that any or all of the projection surfaces could be offset from a vertical orientation by an angle Φ. FIG. 6 illustrates three potential positions for projections surfaces 8, namely, vertical, tipped toward the viewer, and tipped away from the viewer. In still alternate embodiments one or more projection surfaces may be offset or tipped toward the viewer while at the same time one or more projection surfaces may be offset or tipped away from the viewer. The visual effect of offsetting one or more of the projection surfaces is to present a simulated flame image that appears to be either coming out toward the viewer or is being blown away from the viewer, as can be the case in a real burning fire under the influence of wind or other external air movement.

The disclosure also contemplates different shapes and sizes for projection surfaces 8. For example, the projection surfaces may be planar, or may be whole, or in part, nonplanar with curves or contours. FIG. 7 demonstrates five different potential forms of projection surfaces that could be used. Projection surface A represents a generally planar projection surface. Projection surface B is concave in a vertical orientation. Projection surface C is an example of a projection surface that is in the form of a wave in plan view. Projection surface D is concave in a horizontal orientation. Projection surface E demonstrates a wave pattern when viewed from the end of the projection surface. In one embodiment the simulated flame mechanism may comprise a plurality of projection surfaces, which may be alike or which may be any combination of one or more of the types shown in FIG. 7.

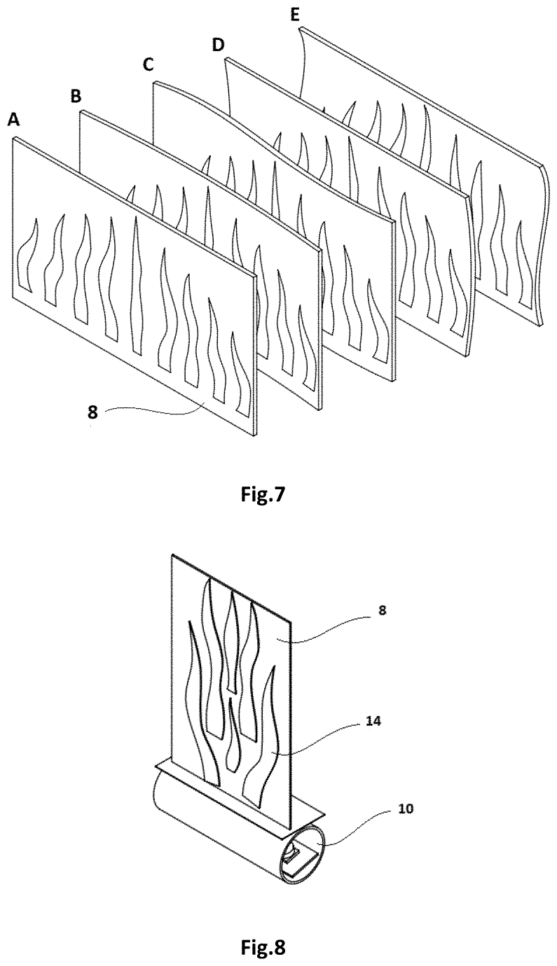

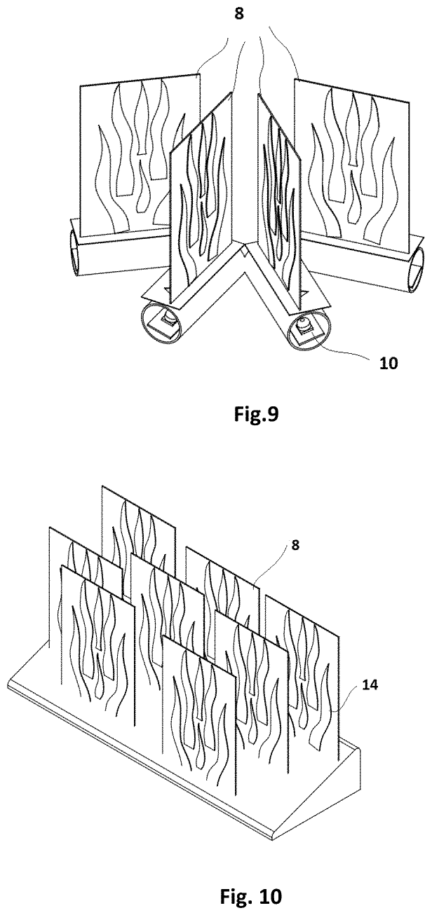

One or more of the projection surfaces may contain flame effects 14 (see generally FIG. 8). Flame effects 14 could take the form of holographic film, painted, or other effect on surface 8 that is designed to enhance a natural flame and/or three-dimensional flame appearance when light from the flicker element is cast upon the projection surface. Flame effect 14 may also comprise one or more flame cut-outs that, together with the light that is cast upon the surface by the flicker element, enhances the displayed image of a moving flame.

Depending on the application and the desired image, projection surfaces 8 may be oriented in an angular or intersecting manner, or may be oriented in other discrete manners to create a customized flame appearance. For example, FIG. 9 illustrates the use of four projection surfaces 8 that are oriented in a manner such that they appear to intersect at approximately the same point to mimic the appearance of a bonfire or campfire. In the case of FIG. 10, there is illustrated an embodiment of the disclosure where multiple projection surfaces are oriented in a discrete and customized manner, offset at different elevations at different locations within housing 2, and offset relative to one another in a side to side relationship within the housing to mimic a more randomized and elongate fire.

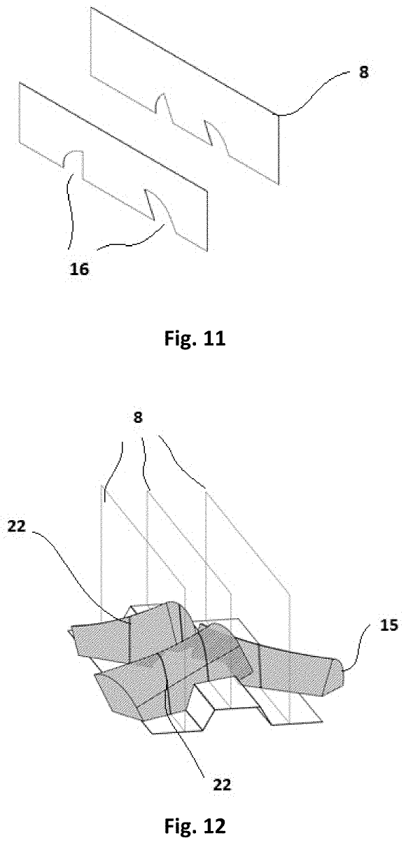

In some applications it is expected that electric fireplace 1 will also include a simulated fire log set 15, similar to that which exists in many current electric and gas burning fireplaces. In an embodiment of the disclosure, one or more projection surfaces 8 may include openings 16 through which a simulated log of fire log set 15 may extend. In this instance, the extension of a fire log through an associated projection surface will enable the presentation of the image of a burning flame that appears to emanate directly from a burning log, adding further to the realistic effect and three-dimensional effect that is created (see FIG. 11). In an alternate embodiment, the fire log set 15 may be formed with a slot or slots 22 for the receipt of one or more projection surfaces therein, and to support the projection surface or surfaces at a desired positon vis-à-vis the fire log set and at a desired degree of inclination from horizontal (see FIG. 12). It will be understood that the embodiment of FIG. 12 can create essentially the same image of a burning fire through a slightly different structure compared to that of FIG. 11. In the case of a see-through or two sided fireplace, a slot 22 positioned approximately at the mid-point of the fire log set, may be used to retain a centrally located projection surface upon which can be projected two separate images of a burning flame (one on each side of the projection surface) to present the illusion of a burning fire from either side of the fireplace.

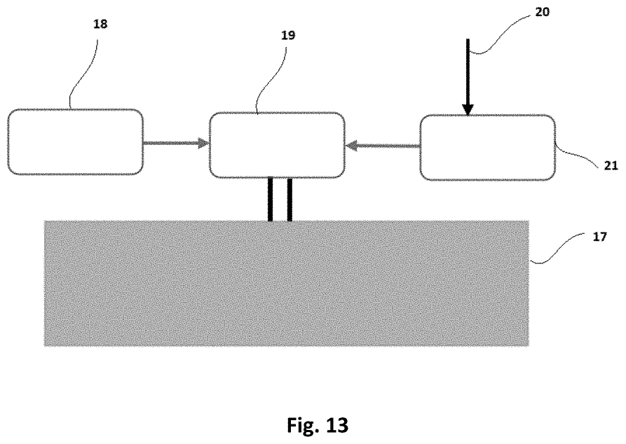

In still a further embodiment, one or more projection surfaces 8 may comprise or have associated with it electrochromic glass or smart glass (also known as polymer dispersed liquid crystal display or PDLC glass). That is, the entire projection surface could potentially be formed from electrochromic glass, or a portion of the projection surface may be fitted with electrochromic glass. FIG. 13 is a schematic drawing showing the primary components that would be used where electrochromic glass is present. Here, electrochromic glass 17 is connected to a power source 18 that would commonly feed a transformer 19, that powers glass 17. A user would typically control the degree of transparency of glass 17 through a user input 20 (which may be a manual control, a app on a smart phone, etc) that is received by a controller or processor 21. Alternately, processor 21 could be programmed to control the degree of transparency of glass 17 in accordance with predetermined parameters according to the degree or “extent” of a burning fire that is to be mimicked, and other factors that impact the overall visual appearance that is created. Processor 21 may also control both flicker effect 9 and the electrochromic glass 17 in order to utilize both the flicker effect and the electrochromic glass to yet further enhance the generated image of a burning flame.

From a thorough understanding of the disclosure it will be appreciated that a combination of the number, shape, angular orientation, and vertical offset of a plurality of projection surfaces 8 helps to create an appearance of a more realistic, three-dimensional fire. Flicker effects 9 that can vary colour, speed of movement/rotation, intensity, sequencing, and layering add further to the overall natural appearance. Light can be projected from the flicker effects at different angles and elevations, and through one or more different lenses. Further, the orientation of individual projection services both relative to fireplace 1 and relative to each other adds to the overall three-dimensional effect.

It is to be understood that what has been described are the preferred embodiments of the disclosure. The scope of the claims should not be limited by the preferred embodiments set forth above, but should be given the broadest interpretation consistent with the description as a whole.

What is claimed is:

1. A simulated flame mechanism for use in an electric fireplace, the simulated flame mechanism comprising:
two or more projection surfaces, spaced apart and oriented relative to each other by one or more of (i) different elevations, (ii) different angular orientations in a horizontal plane, and (iii) different orientations in a vertical plane; and
one or more flicker effects transmitting light onto the two or more projection surfaces and generating an image of a simulated flame on each of the projection surfaces, wherein the spacing and orientation of the two or more projection surfaces relative to each other creates a three-dimensional flame appearance when light from the one or more flicker effects is transmitted thereto.

2. The simulated flame mechanism as claimed in claim 1 wherein the projection surfaces are oriented in a stepped configuration relative to each other at different elevations such that the projection of light onto the projection surfaces creates an appearance of flames of different heights at different depths within the fireplace.

3. The simulated flame mechanism as claimed in claim 1 wherein at least one of the projection surfaces is oriented at an angle relative to vertical.

4. The simulated flame mechanism as claimed in claim 1 wherein at least one of the projection surfaces is oriented at an angle relative to vertical and at least one of the projection surfaces is approximately vertical.

5. The simulated flame mechanism as claimed in claim 1 wherein each of the projection surfaces has it its own dedicated flicker effect, each of the projection surfaces receiving projections from its dedicated flicker effect, or from its dedicated flicker effect and from another flicker effect or source.

6. The simulated flame projection surface as claimed in claim 1 wherein at least one of the projection surfaces is non-planar and has curves or contours.

7. The simulated flame mechanism as claimed in claim 1 wherein at least one of the projection surfaces comprises electrochromic glass, wherein the electric fireplace includes a processor, and wherein the processor controls the flicker effect and the electrochromic glass.

8. The simulated flame mechanism as claimed in claim 1 wherein one or more of the projection surfaces includes a holographic film, the holographic film enhancing the three-dimensional flame appearance when light from the flicker effect is cast thereon.

9. The simulated flame mechanism as claimed in claim 1 comprising a simulated fire log set, the simulated fire log set comprising one or more simulated logs, one or more of the projection surfaces having an opening to receive a simulated log therethrough.

10. The simulated flame mechanism as claimed in claim 1 comprising a simulated fire log set, the simulated fire log set comprising one or more simulated logs and having one or more slots to receive and retain one or more of the projection surfaces therein.

11. The simulated flame mechanism as claimed in claim 1 wherein the two or more projection surfaces comprise a first, a second, and a third projection surface,
wherein the first, second, and third projection surfaces are positioned side by side and aligned generally parallel to one another with the second projection surface located between the first and the third projection surfaces, and
wherein the second projection surface projection surface extends vertically higher than the first and the third projection surfaces.

12. The simulated flame mechanism as claimed in claim 1 wherein the two or more projection surfaces comprise a first, a second and a third projection surface,
wherein the first, second and third projection surfaces are oriented side by side and arranged in generally parallel rows with the second projection surface located between the first and the third projection surfaces,
wherein the first projection surface has a vertical height less than the second and third projection surfaces, and the second projection surface has a vertical height less than the third projection surface, and
wherein each of the first, second and third projection surfaces has its own dedicated flicker effect, and receives projections from its dedicated flicker effect, or from its dedicated flicker effect and from another flicker effect or source.

13. The simulated flame mechanism as claimed in claim 1 wherein the two or more projection surfaces comprise three or more projection surfaces oriented in generally vertical planes and positioned in an intersecting manner, each of the projection surfaces having its own dedicated flicker effect.

14. A simulated flame mechanism for use in an electric fireplace, the simulated flame mechanism comprising:
a first, a second, and a third projection surface, the first, second and third projection surfaces spaced apart from one another with the second projection surface positioned between the first and the third projection surfaces, the first, second, and third projection surfaces oriented in a stepped configuration with the first projection surface at a first elevation, the second projection surface at a second elevation, and the third projection surface at a third elevation, the second elevation being greater than the first elevation and the third elevation being greater than the second elevation, and
a flicker effect associated with each of the projection surfaces, each flicker effect transmitting light onto its respective projection surface to generate an image of a simulated flame on the respective projection surface,
wherein the spacing apart of the projection surfaces and their stepped configuration creates a three-dimensional flame appearance when light from the flicker effects is transmitted onto the projection surfaces.

15. The simulated flame mechanism as claimed in claim 14 wherein at least one of the projection surfaces is oriented at an angle relative to vertical.

16. The simulated flame mechanism as claimed in claim 14 wherein at least one of the projection surfaces is oriented at an angle relative to vertical and at least one of the projection surfaces is approximately vertical.

17. The simulated flame mechanism as claimed in claim 14 wherein one or more of the projection surfaces is non-planar and has curves or contours.

18. The simulated flame mechanism as claimed in claim 14 wherein at least one of the projection surfaces comprises electrochromic glass, wherein the electric fireplace includes a processor, and wherein the processor controls the electrochromic glass and the flicker effect associated with the at least one of the projection surfaces to together create a desired image on the at least one of the projection surfaces.

19. The simulated flame mechanism as claimed in claim 14 wherein one or more of the projection surfaces includes a holographic film, the holographic film enhancing the three-dimensional flame appearance when light from an associated flicker element is cast thereon.

20. The simulated flame mechanism as claimed in claim 14 comprising a simulated fire log set having one or more simulated logs, one or more of the projection surfaces having an opening to receive a simulated log therethrough.

21. The simulated flame mechanism as claimed in claim 14 comprising a simulated fire log set, the simulated fire log set comprising one or more simulated logs and having one or more slots to receive and retain one or more of the projection surfaces therein.

22. A simulated flame mechanism for use in an electric fireplace, the simulated flame mechanism comprising:
two or more projection surfaces oriented relative to one another by one or more of (i) different elevations, (ii) different angular orientations in a horizontal plane, and (iii) different angular orientations in a vertical plane,
a flicker effect associated with each of the projection surfaces, each flicker effect generating the image of a simulated flame on its respective projection surface, and
a simulated fire log set comprising one or more simulated fire logs, one or more of the projection surfaces having an opening to receive a simulated fire log therethrough.

23. The simulated flame mechanism as claimed in claim 22 wherein the two or more projection surfaces comprise a first, a second and a third projection surface, the first, second, and third projection surfaces being generally parallel to each other, the first projection surface being adjacent to a front viewing window of the electric fireplace, the third projection surface being adjacent to a rear surface of the electric fireplace, the second projection surface being positioned between the first and the third projection surfaces, the first projection surface having a first height, the second projection surface having a second height, and the third projection surface having a third height, wherein the second height is greater than the first height and the third height is greater than the second height.
